(19) United States
(12) Patent Application Publication
(10) Pub. No.: US 2026/0279646 A1
(43) Pub. Date: Sep. 17, 2026

(54) COIL COMPONENT

(71) Applicant: SUMIDA CORPORATION, Tokyo (JP)

(72) Inventors: Kei TANAKA, Natori City (JP); Hitoshi MORIYA, Natori City (JP); Asami MURAKAMI, Natori City (JP)

(21) Appl. No.: 19/470,248

(22) PCT Filed: Apr. 7, 2023
(86) PCT No.: PCT/JP2023/014433

§ 371 Date: Sep. 29, 2025

(51) Int. Cl. H01F 27/26; H01F 17/00; H01F 17/04

(52) U.S. Cl. CPC H01F 27/263; H01F 17/04; H01F 2017/0093

(57) ABSTRACT

A coil component includes: a magnetic core formed in an annular shape and having a structure divided into a plurality of divided cores in a circumferential direction; a coil wound around the magnetic core; a main body member holding the magnetic core; and a plurality of terminal members made of metal and each electrically connected to the coil, in which the main body member integrally includes a base portion provided with the plurality of terminal members and in which the magnetic core is disposed, a cover portion covering the magnetic core, and a connecting portion connecting the base portion and the cover portion to each other.

### CROSS REFERENCE TO RELATED APPLICATIONS

This application is a 371 U.S. National Phase of International Application No. PCT/JP2023/014433, filed on Apr. 7, 2023. The entire disclosure of the above application is incorporated herein by reference.

### BACKGROUND

### Technical Field

The present invention relates to a coil component.

### Related Art

As a coil component, for example, there is one described in JP H02-146707 A (Patent Document 1).

The coil component of Patent Document 1 includes a magnetic core formed in an annular shape, a coil wound around the magnetic core, a base portion holding the magnetic core, and a cover portion covering the magnetic core, and the base portion and the cover portion are constituted by individual members.

According to the study of the inventor of the present application, there is room for improvement in the structure of the coil component of Patent Document 1 from the viewpoint of more reliably ensuring structural strength between the base portion and the cover portion.

The present invention has been made in view of the above problems, and provides a coil component having a structure capable of more reliably ensuring structural strength of the coil component.

### SUMMARY

According to the present invention, there is provided a coil component including:
a magnetic core formed in an annular shape and having a structure divided into a plurality of divided cores in a circumferential direction,
a coil wound around the magnetic core,
a main body member holding the magnetic core, and
a plurality of terminal members made of metal and each electrically connected to the coil, in which
the main body member integrally includes a base portion provided with the plurality of terminal members and in which the magnetic core is disposed, a cover portion covering the magnetic core, and a connecting portion connecting the base portion and the cover portion to each other.

### EFFECT OF THE INVENTION

According to the present invention, structural strength of a coil component can be ensured more reliably.

### BRIEF DESCRIPTION OF THE DRAWINGS

FIG. 1 is a perspective view of a coil component according to an embodiment.

FIG. 2 is an exploded perspective view of the coil component according to the embodiment.

FIG. 3 is a plan view of a coil component according to the embodiment.

FIG. 4 is a bottom view of the coil component according to the embodiment.

FIG. 5 is a cross-sectional view taken along line A-A illustrated in FIG. 3.

FIG. 6 is a front view of the coil component according to the embodiment.

FIG. 7 is a perspective view of a main body member in the embodiment.

FIG. 8 is a side view of the main body member in the embodiment.

FIG. 9 is a partially enlarged view illustrating a first core arrangement portion and a peripheral structure thereof in the embodiment, and is a cross-sectional view taken along line A-A illustrated in FIG. 6.

FIGS. 10A and 10B are views illustrating a divided core of a magnetic core in the embodiment, in which FIG. 10A is a plan view and FIG. 10B is a cross-sectional view taken along line A-A illustrated in FIG. 10A.

FIG. 11A is a partially enlarged view of a first fitting recess, and FIG. 11B illustrates a state in which a terminal member is fitted into a fitting recess from a state illustrated in FIG. 11A.

FIG. 12A is a cross-sectional view taken along line A-A illustrated in FIG. 11A, and FIG. 12B illustrates a state in which the terminal member is fitted into the fitting recess from a state illustrated in FIG. 12A.

FIGS. 13A and 13B are views illustrating a magnetic core in a modification of the embodiment, in which FIG. 13A is a plan view and FIG. 13B is a cross-sectional view taken along line A-A illustrated in FIG. 13A.

### DETAILED DESCRIPTION

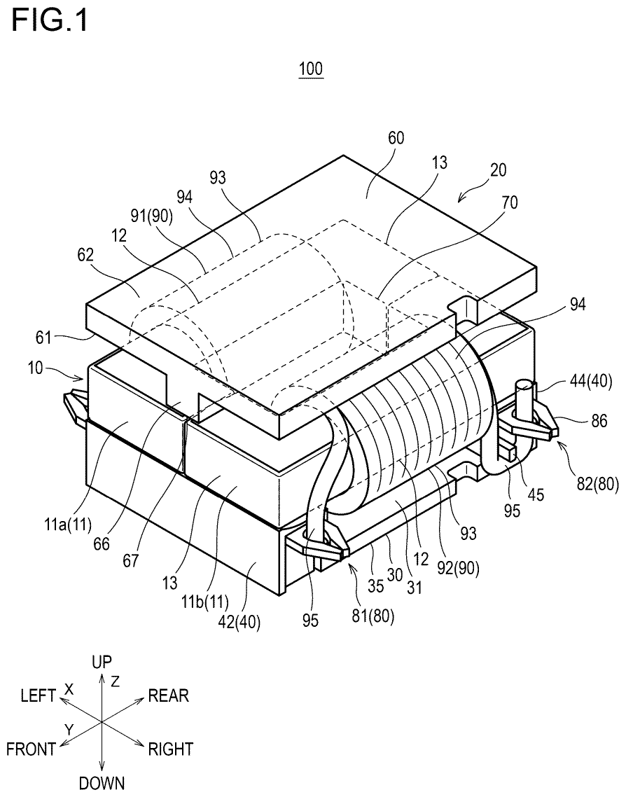

Hereinafter, an embodiment of the present invention will be described with reference to FIGS. 1 to 13B.

Note that, in all the drawings, the same components are denoted by the same reference numerals, and the description thereof will not be repeated.

As illustrated in FIGS. 1 to 5, a coil component 100 according to the present embodiment includes a magnetic core 10 that is formed in an annular shape and has a structure divided into a plurality of divided cores 11 in the circumferential direction, coils 90 wound around the magnetic core 10, a main body member 20 holding the magnetic core 10, and a plurality of metal terminal members 80 to which the coils 90 are electrically connected.

The main body member 20 integrally includes a base portion 30 provided with a plurality of terminal members and in which the magnetic core 10 is disposed, a cover portion 60 covering the magnetic core 10, and a connecting portion 70 connecting the base portion 30 and the cover portion 60 to each other.

Here, “integrally formed” means that the entire main body member 20 including the base portion 30, the cover portion 60, and the connecting portion 70 is integrally formed.

Here, “covering the magnetic core 10” means that the cover portion 60 overlaps at least a portion of the magnetic core 10 in a plan view, and in the case of the present embodiment, as described later, the entire magnetic core 10 is accommodated inside the outline of the cover portion 60 in a plan view (the entire magnetic core 10 overlaps the cover portion 60).

According to the present embodiment, the base portion 30 provided with the plurality of terminal members and in which the magnetic core 10 is disposed, the cover portion 60 covering the magnetic core 10, and the connecting portion 70 connecting the base portion 30 and the cover portion 60 to each other are integrated.

Thus, as compared with a case where the base portion 30 and the cover portion 60 are separate members and the main body member 20 is configured by combining the separate members as in Patent Document 1, the structural strength of the main body member 20 and the coil component 100 can be ensured more reliably.

In addition, since the base portion 30 and the cover portion 60 are formed of one member, the number of molds required for manufacturing the coil component 100 can be reduced.

Furthermore, since the magnetic core 10 is divided into the plurality of divided cores 11, even if the base portion 30 and the cover portion 60 are integrated, the magnetic core 10 (the plurality of divided cores 11) can be easily assembled to the main body member 20 and the cover portion 60.

As described above, according to the present embodiment, it is also possible to improve the ease of manufacturing the coil component 100.

Hereinafter, the coil component 100 according to the present embodiment will be described in more detail.

Note that, in the following description, the vertical direction is referred to as a Z direction. A lower side (lower side) is a side to which the terminal member 80 (FIG. 1 and the like) to be described later is disposed, that is, a mounting surface side where the coil component 100 is mounted. However, the positional relationship of each part (particularly, the vertical positional relationship) at the time of manufacturing or using the coil component 100 is not limited to the positional relationship described in the present specification.

An axial direction of a coil 90 extends in a direction orthogonal to the Z direction. The axial direction of the coil 90 is referred to as a Y direction, one side in the Y direction is referred to as a front (front side), and the other side is referred to as a rear (rear side).

Further, a direction orthogonal to both the Y direction and the Z direction is referred to as an X direction, one side in the X direction is referred to as a right side (right side), and the other side is referred to as a left side (left side).

These directions are illustrated in the respective drawings.

Furthermore, in the Y direction, a side on which a center position of the coil 90 in the axial direction is located is referred to as an inner side (inner side), and a side opposite to the inner side is referred to as an outer side (outer side). Further, in the X direction, a side on which a connecting portion 70 is present is referred to as an inner side (inner side), and a side opposite to the inner side is referred to as an outer side (outer side).

Further, a direction (direction) orthogonal to the Z direction is referred to as horizontal (horizontal direction), and a direction (direction) along the Z direction is referred to as vertical (vertical direction).

As illustrated in FIGS. 1, 5, and 6, in the case of the present embodiment, the base portion 30 and the cover portion 60 have facing surfaces 31 and 61 facing each other, respectively.

The connecting portion 70 is interposed between the facing surfaces 31 and 61 of the base portion 30 and the cover portion 60, and connects the facing surfaces 31 and 61 to each other.

The plurality of divided cores 11 (in the case of the present embodiment, the first magnetic core 11a and the second magnetic core 11b described below) is disposed on the facing surface 31 of the base portion 30.

With such a configuration, the plurality of divided cores 11 (magnetic cores 10) can be stably held between the base portion 30 and the cover portion 60.

In the case of the present embodiment, the facing direction of the base portion 30 and the cover portion 60 is the vertical direction, and the base portion 30 is disposed on the lower side and the cover portion 60 is disposed on the upper side with respect to the magnetic core 10. Therefore, the facing surface 31 of the base portion 30 is the upper surface of the base portion 30, and the facing surface 61 of the cover portion 60 is the lower surface of the cover portion 60.

However, in the present invention, the facing direction of the base portion 30 and the cover portion 60 is not limited to the above-described example, and can be appropriately set according to the structure of each member constituting the coil component 100, the positional relationship between members to be implemented, and the like.

As described above, the magnetic core 10 is formed in an annular shape and has a structure divided into a plurality of divided cores 11 in the circumferential direction.

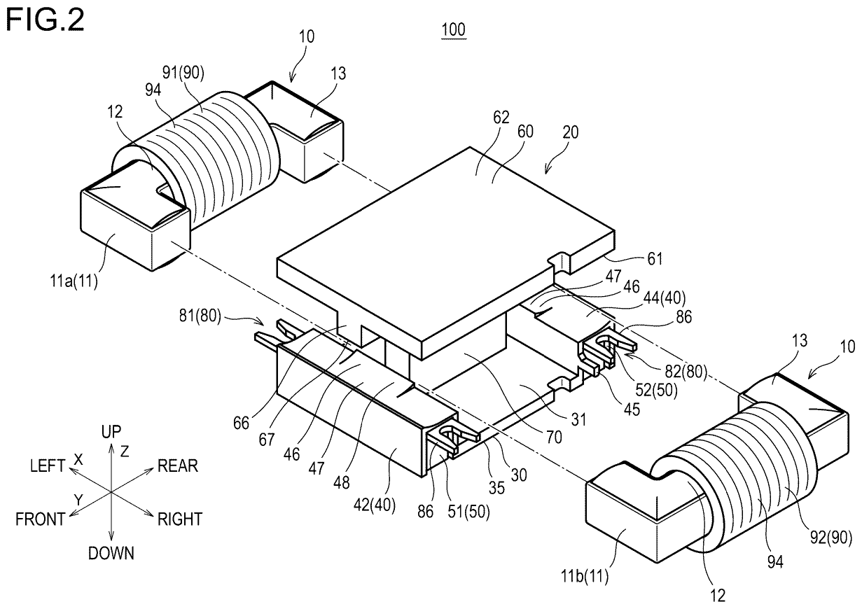

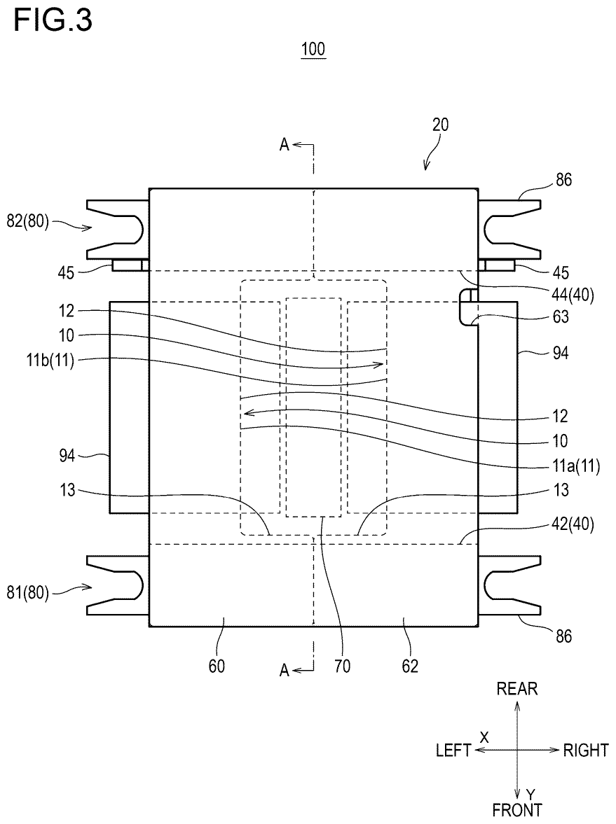

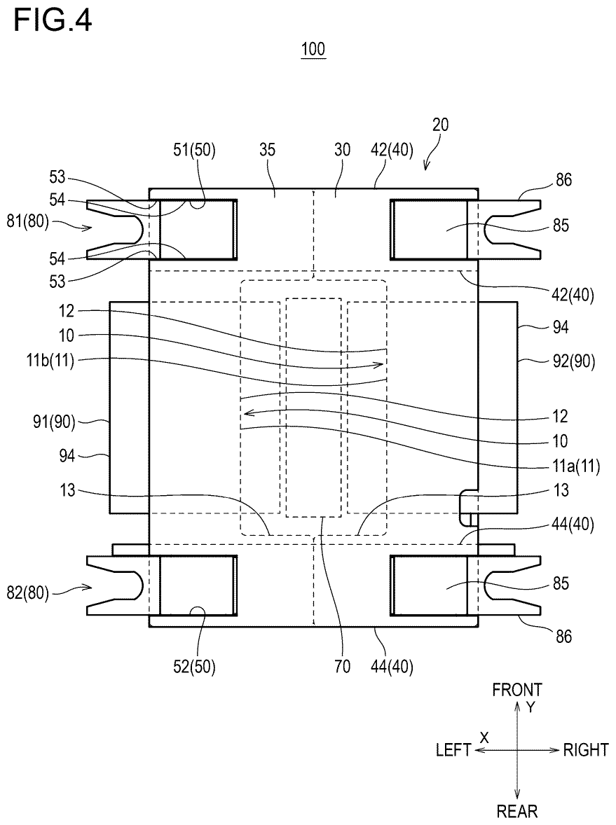

More specifically, as illustrated in FIG. 2, the magnetic core 10 includes, as the divided core 11, for example, a pair of left and right core members, that is, a first magnetic core 11a disposed on the left side and a second magnetic core 11b arranged on the right side. For example, the first magnetic core 11a and the second magnetic core 11b are arranged to face each other and are combined with each other to be arranged in a rectangular annular shape in plan view (see FIGS. 3 and 4).

Then, the first magnetic core 11a and the second magnetic core 11b constitute a closed magnetic circuit.

The first magnetic core 11a and the second magnetic core 11b are formed, for example, in the same shape and the same dimension, and are arranged symmetrically to each other.

More specifically, in the case of the present embodiment, each of the first magnetic core 11a and the second magnetic core 11b is, for example, a so-called U core, and has a planar shape formed in a U shape.

The first magnetic core 11a includes a base portion 12 extending in the front-rear direction and a pair of outer legs 13 protruding rightward from both ends of the base portion 12.

The base portion 12 is formed in, for example, a substantially prismatic shape elongated in the front-rear direction. Similarly, each outer leg 13 is formed in, for example, a substantially prismatic shape elongated laterally. In the base portion 12 and each of outer legs 13, two of four surfaces arranged around an axis are an upper surface and a lower surface arranged substantially horizontally, one of the remaining two surfaces (hereinafter, an inner surface) faces the second magnetic core 11b side, and the other (hereinafter, an outer surface) faces a side opposite to the second magnetic core 11b.

Similarly to the first magnetic core 11a, the second magnetic core 11b includes a base portion 12 and a pair of outer legs 13. However, in the case of the second magnetic core 11b, the pair of outer legs 13 protrudes leftward from both ends of the base portion 12.

Here, in the magnetic core 10, the entire surface on the base portion 30 side (in the case of the present embodiment, a lower surface) is a first convex curved surface 14 that is convex toward the base portion 30, and the entire surface on the cover portion 60 side (in the case of the present embodiment, an upper surface) is a second convex curved surface 15 that is convex toward the cover portion 60. That is, each of the lower surface and the upper surface of the magnetic core 10 has a rounded shape.

Note that “the entire surface on the base portion 30 side” as used herein means that the surface on the base portion 30 side is substantially the entire surface in the magnetic core 10, and specifically, at least 80% or more (more preferably 90% or more) is preferably the first convex curved surface 14. The surface on the base portion 30 side may include, for example, a slightly flat surface. Similarly, “the entire surface on the cover portion 60 side” means that the surface on the cover portion 60 side is substantially the entire surface in the magnetic core 10, and specifically, at least 80% or more (more preferably 90% or more) is preferably the second convex curved surface 15. The surface on the cover portion 60 side may include, for example, a slightly flat surface.

With such a configuration, as compared with a case where the upper surface and the lower surface of the magnetic core 10 are flat surfaces, a winding 93 of the coil 90 can be wound around the magnetic core 10 in a shape closer to a cylindrical shape (see FIG. 2 and the like) along the first convex curved surface 14 and the second convex curved surface 15. Therefore, the winding 93 of the coil 90 can be wound around the magnetic core 10 while suppressing stress from being applied to the winding 93.

More specifically, in the case of the present embodiment, the first convex curved surface 14 of the magnetic core 10 is constituted by a lower surface of the base portion 12 and a lower surface of each of the outer legs 13. Further, the second convex curved surface 15 of the magnetic core 10 is constituted by the upper surface of the base portion 12 and the upper surface of each of the outer legs 13.

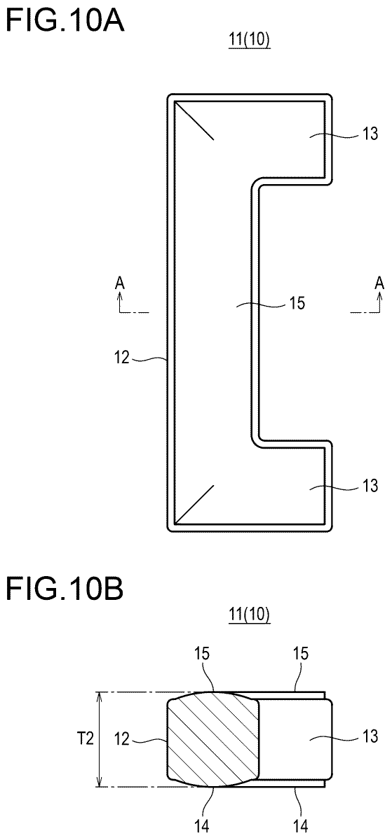

As illustrated in FIG. 10B, in the cross section orthogonal to an extending direction of the base portion 12, the upper surface of the base portion 12 is formed in an arc shape protruding upward, and the lower surface of the base portion 12 is formed in an arc shape protruding downward. However, respective side edge portions of the upper surface and the lower surface of the base portion 12 are slightly flat surfaces. Further, a curvature radius of each of the upper surface and the lower surface is substantially constant regardless of the position of the base portion 12 in the extending direction. However, in each of one end and the other end of the base portion 12, the curvature radius of each of the upper surface and the lower surface is slightly larger than the curvature radius of the other portion.

Similarly, in the cross section orthogonal to the extending direction of outer leg 13, the upper surface of outer leg 13 is formed in an upward convex arc shape, and the lower surface of outer leg 13 is formed in a downward convex arc shape. However, respective side edge portions of the upper surface and the lower surface of the outer leg 13 are slightly flat surfaces. The curvature radius of each of the upper surface and the lower surface is constant regardless of the position of the outer leg 13 in the extending direction.

In the case of the present embodiment, the curvature of the first convex curved surface 14 and the curvature radius of the second convex curved surface 15 are equal to each other. However, the present invention is not limited to this example, and the curvature radius of the first convex curved surface 14 and the curvature radius of the second convex curved surface 15 may be different from each other.

Furthermore, as illustrated in FIG. 10A, in the case of the present embodiment, the lower surface of the base portion 12 and the lower surface of each of the outer legs 13 are continuously formed with each other, and an assembly of the lower surface of the base portion 12 and the lower surface of each of the outer legs 13 forms a convex curved surface (first convex curved surface 14) that is smoothly convex downward as a whole.

Similarly, the upper surface of the base portion 12 and the upper surface of each of the outer legs 13 are continuously formed with each other, and an assembly of the upper surface of the base portion 12 and the upper surface of each of the outer legs 13 forms a convex curved surface (second convex curved surface 15) that is smoothly convex upward as a whole.

Further, a distal end surface of each of the first magnetic core 11a and the second magnetic core 11b in the protruding direction of the outer leg 13 is formed flat and is a vertical surface orthogonal to the axial direction of the coil 90.

As illustrated in FIG. 3, the inner surface and the outer surface of the base portion 12 are also formed flat and are vertical surfaces orthogonal to the axial direction of the coil 90. The inner surface of the base portion 12 of the first magnetic core 11a and the inner surface of the base portion 12 of the second magnetic core 11b face each other, and the outer surface of the base portion 12 of the first magnetic core 11a and the outer surface of the base portion 12 of the second magnetic core 11b face opposite directions.

However, in the present invention, the inner surface of the base portion 12 may be, for example, a convex curved surface that is convex inward, and the outer surface of the base portion 12 may also be, for example, a convex curved surface that is convex outward.

Similarly, in the present invention, the inner surface of the outer leg 13 may be, for example, a convex curved surface that is convex inward, and the outer surface of the outer leg 13 may also be, for example, a convex curved surface that is convex outward.

In addition, the magnetic core 10 includes, for example, a first portion around which the coil 90 is wound and a second portion around which the coil 90 is not wound.

With such a configuration, in the magnetic core 10, by arranging the second portion around which the coil 90 is not wound, of the first portion and the second portion, in the base portion 30, it is possible to suppress the base portion 30 from interfering with the coil 90 while the magnetic core 10 is favorably supported by the base portion 30.

In the case of the present embodiment, the coil 90 is wound around an intermediate portion (intermediate portion in an extending direction) of the base portion 12 of each of the first magnetic core 11a and the second magnetic core 11b. On the other hand, a front end portion of the base portion 12 protrudes forward from the coil 90, and a rear end portion of the base portion 12 protrudes rearward from the coil 90. Then, the coil 90 is not wound around each of the outer legs 13 of each of the first magnetic core 11a and the second magnetic core 11b. That is, in the case of the present embodiment, the intermediate portion of the base portion 12 of each of the first magnetic core 11a and the second magnetic core 11b is the first portion, and a front end portion and a rear end portion of the intermediate portion and each of the outer legs 13 are the second portion.

However, in the case of the present embodiment, as described above, in the magnetic core 10, the entire lower surface is the first convex curved surface 14 that is convex downward, and the entire upper surface is the second convex curved surface 15 that is convex upward.

Therefore, in the magnetic core 10, a portion constituting a first portion around which the coil 90 is wound is not limited to this example, and may be wound around the outer leg 13, for example.

More specifically, as illustrated in FIGS. 1 and 2, in the case of the present embodiment, the coil 90 includes a first coil 91 wound around the first magnetic core 11a and a second coil 92 wound around the second magnetic core 11b.

Each of the first coil 91 and the second coil 92 includes the winding 93. The winding 93 of each of the first coil 91 and the second coil 92 is wound around the base portion 12 of the corresponding divided core 11 (the first magnetic core 11a and the second magnetic core 11b). The winding 93 wound around the base portion 12 constitutes a winding portion 94 (see FIG. 2). Both end portions of each winding 93 are electrically connected to a corresponding terminal member 80. As an example, both end portions of each winding 93 are pulled out from the winding portion 94 and fixed to the corresponding terminal member 80, thereby being electrically connected to the terminal member 80 (see FIG. 1). Note that, in FIGS. 2 to 5, a portion (lead wire 95) drawn out from the winding portion 94 in the winding 93 and an end portion of the winding 93 are not shown.

As described above, the main body member 20 integrally includes the base portion 30 provided with the plurality of terminal members and in which the magnetic core 10 is disposed, the cover portion 60 covering the magnetic core 10, and the connecting portion 70 connecting the base portion 30 and the cover portion 60 to each other.

As illustrated in FIGS. 2, 3, and 5, the cover portion 60 is formed in, for example, a flat plate shape, and includes a main body portion 62 arranged horizontally. Then, a positioning protruding portion 66 to be described later is formed on the main body portion 62. In the case of the present embodiment, in the cover portion 60, the facing surface 61 (the lower surface of the cover portion 60) facing the facing surface 31 of the base portion 30 is constituted by the lower surface of the main body portion 62 and the lower surface 67 of the positioning protruding portion 66. Then, the facing surface 61 is disposed horizontally.

As illustrated in FIG. 3, the planar shape of the main body portion 62 is, for example, a substantially rectangular shape. A cutout shape portion 63 is formed in a rear right side portion of the main body portion 62. The directions of the cover portion 60 and the main body member 20 can be easily determined by the cutout shape portion 63.

Since the main body member 20 includes the cover portion 60, when the coil component 100 is mounted on a substrate, the cover portion 60 can be attracted by a mounter, and the operation of mounting the coil component 100 on the substrate can be easily performed. Note that the cover portion 60 need not be formed flat, for example.

As illustrated in FIGS. 2, 6, 8, and the like, the base portion 30 includes, for example, a core arrangement portion 40 in which the magnetic core 10 is disposed. More specifically, the base portion 30 includes, as the core arrangement portion 40, for example, a pair of front and rear core arrangement portions 40, that is, a first core arrangement portion 42 arranged on a front side and a second core arrangement portion 44 arranged on a rear side. As illustrated in FIG. 1 and the like, the first magnetic core 11a and the second magnetic core 11b are held in a state of being arranged in a rectangular annular shape in plan view by the first core arrangement portion 42 and the second core arrangement portion 44.

Then, the base portion 30 further includes a plate-shaped portion 35 which connects the first core arrangement portion 42 and the second core arrangement portion 44 to each other.

In the case of the present embodiment, the upper surface of the facing surface 31 (base portion 30) facing the facing surface 61 of the cover portion 60 is constituted by an upper surface of each of the first core arrangement portion 42 and the second core arrangement portion 44 and an upper surface of the plate-shaped portion 35.

The plate-shaped portion 35 is formed in a flat plate shape and is disposed horizontally. The planar shape of the plate-shaped portion 35 is, for example, a substantially rectangular shape.

A front edge portion of the plate-shaped portion 35 is connected to the first core arrangement portion 42, and a rear edge portion of the plate-shaped portion 35 is connected to the second core arrangement portion 44. Further, a lower surface of the plate-shaped portion 35 is disposed flush with a lower surface of each of the first core arrangement portion 42 and the second core arrangement portion 44.

For example, the first core arrangement portion 42 and the second core arrangement portion 44 are formed in substantially the same shape and the same dimension, and are arranged to be longitudinally symmetrical to each other.

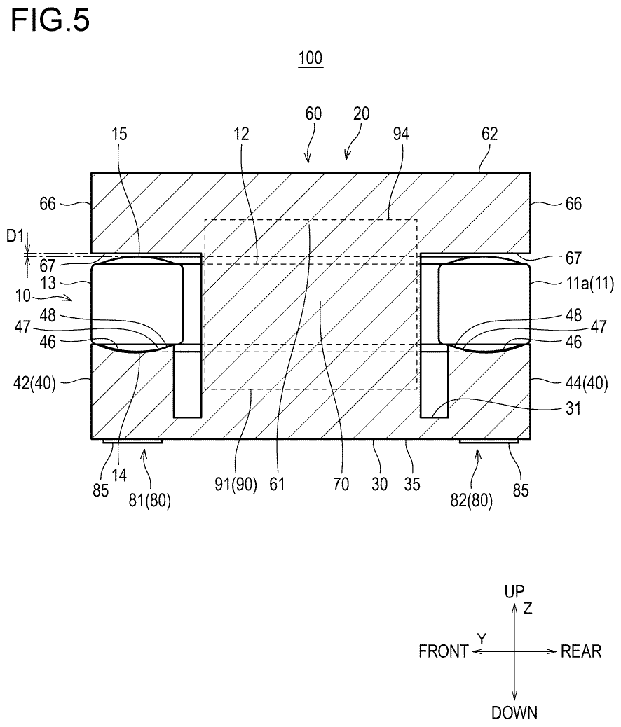

More specifically, as illustrated in FIGS. 5, 7, and 8, each of the first core arrangement portion 42 and the second core arrangement portion 44 is formed in, for example, a substantially prismatic shape elongated laterally. However, as illustrated in FIGS. 1 and 3 and the like, in the case of the present embodiment, extending portions 45 extending outward are formed at both end portions of the second core arrangement portion 44. As illustrated in FIG. 1, the lead wire 95 drawn out from the coil 90 can be locked to the extending portion 45.

Each of the first core arrangement portion 42 and the second core arrangement portion 44 is provided with a plurality of terminal members 80 (details will be described later).

As illustrated in FIG. 3 and the like, in the case of the present embodiment, the outer leg 13 on the front side of the first magnetic core 11a and the outer leg 13 on the front side of the second magnetic core 11b are arranged on an intermediate portion (intermediate portion in the extending direction) of the first core arrangement portion 42.

Similarly, the outer leg 13 on a rear side of the first magnetic core 11a and the outer leg 13 on a rear side of the second magnetic core 11b are arranged on an intermediate portion (same as above) of the second core arrangement portion 44.

Further, as illustrated in FIG. 3, the base portion 12 of each of the first magnetic core 11a and the second magnetic core 11b is disposed across the first core arrangement portion 42 and the second core arrangement portion 44.

More specifically, in the base portion 12 of the first magnetic core 11a, the front end portion protruding forward from the coil 90 is disposed on a left end portion of the first core arrangement portion 42, and the rear end portion protruding backward from the coil 90 is disposed on a left end portion of the second core arrangement portion 44.

Similarly, in the base portion 12 of the second magnetic core 11b, the front end portion protruding forward from the coil 90 is disposed on a right end portion of the first core arrangement portion 42, and the rear end portion protruding backward from the coil 90 is disposed on a right end portion of the second core arrangement portion 44.

As illustrated in FIGS. 3, 7, 8, and the like, the connecting portion 70 connects, for example, a central portion of the base portion 30 and a central portion of the cover portion 60 to each other.

More specifically, in the case of the present embodiment, the connecting portion 70 is formed in a flat plate shape, and a plate surface thereof is disposed to face a left-right direction. An upper end surface of the connecting portion 70 is connected to a central portion of a lower surface of the main body portion 62 of the cover portion 60, and a lower end surface of the connecting portion 70 is connected to a central portion of the upper surface of the plate-shaped portion 35 of the base portion 30. In this manner, the connecting portion 70 connects the base portion 30 and the cover portion 60 to each other in a state where the base portion 30 and the cover portion 60 face each other in the vertical direction. Then, the upper surface of the plate-shaped portion 35 and the lower surface of the main body portion 62 of the cover portion 60 face each other in the vertical direction and are arranged in parallel.

In the case of the present embodiment, each of the first magnetic core 11a and the second magnetic core 11b is integrally molded by a magnetic material as a whole.

The entire main body member 20 (the base portion 30, the cover portion 60, and the connecting portion 70) is integrally molded with an insulating material such as resin, for example.

Here, in the case of the present embodiment, the plurality of divided cores 11 (the first magnetic core 11a and the second magnetic core 11b) surround the periphery of the connecting portion 70.

With such a configuration, it is possible to easily assemble the plurality of divided cores 11 to the main body member 20 while forming a closed magnetic path by the plurality of divided cores 11.

More specifically, as illustrated in FIG. 3 and the like, in the case of the present embodiment, the distal end surface of the outer leg 13 on the front side of the first magnetic core 11a and the distal end surface of the outer leg 13 on the front side of the second magnetic core 11b butt against each other and are in surface contact with each other. Similarly, the distal end surface of the outer leg 13 on the rear side of the first magnetic core 11a and the distal end surface of the outer leg 13 on the rear side of the second magnetic core 11b butt against each other and are in surface contact with each other.

Further, in the case of the present embodiment, the distal end surface of the outer leg 13 on the front side of the first magnetic core 11a and the distal end surface of the outer leg 13 on the front side of the second magnetic core 11b are fixed to each other by, for example, an adhesive (not shown in the drawings). Similarly, the distal end surface of the outer leg 13 on the rear side of the first magnetic core 11a and the distal end surface of the outer leg 13 on the rear side of the second magnetic core 11b are fixed to each other by an adhesive (not shown in the drawings).

In this manner, the first magnetic core 11a and the second magnetic core 11b are integrally connected to each other to form the magnetic core 10 having an annular shape in plan view. Then, the annular magnetic core 10 is held by the main body member 20 in a state of being extrapolated to the connecting portion 70.

Further, as illustrated in FIG. 4, when viewed in the facing direction of the base portion 30 and the cover portion 60, the entire magnetic core 10 is accommodated inside an outline of the base portion 30.

Note that the expression “the entire magnetic core 10 is accommodated inside an outline of the base portion 30” as used herein means that an outline of the magnetic core 10 does not protrude outward from the outline of the base portion 30 in plan view, and the outline of the magnetic core 10 may overlap the outline of the base portion 30, for example.

With such a configuration, when the coil component 100 is mounted on the substrate, a portion to which the cover portion 60 is attracted by the mounter can be sufficiently secured, and the operation of mounting the coil component 100 on the substrate can be easily performed.

More specifically, in the case of the present embodiment, the longitudinal dimension of the entire base portion 30 (the core arrangement portion 40 and the plate-shaped portion 35) is set to be substantially equal to the longitudinal dimension of the magnetic core 10 (an assembly of the first magnetic core 11a and the second magnetic core 11b). Similarly, the horizontal dimension of the entire base portion 30 (same as above) is set substantially equal to the horizontal dimension of the magnetic core 10 (same as above).

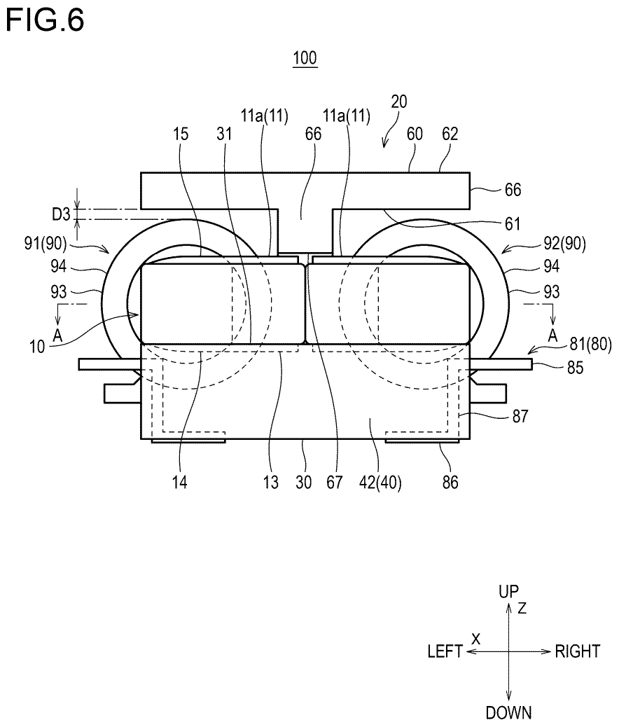

As illustrated in FIG. 6, the outer surface of the base portion 12 of the first magnetic core 11a is disposed substantially flush with a left side end surface of the base portion 30, and the outer surface of the base portion 12 of the second magnetic core 11b is disposed substantially flush with a right side end surface of the base portion 30. As illustrated in FIG. 4, the outer surfaces of the outer leg 13 on the front side of the first magnetic core 11a and the outer leg 13 on the front side of the second magnetic core 11b are disposed substantially flush with a front end surface of the base portion 30. Similarly, the respective outer surfaces of the outer leg 13 on the rear side of the first magnetic core 11a and the outer leg 13 on the rear side of the second magnetic core 11b are arranged substantially flush with a rear end surface of the base portion 30.

As illustrated in FIG. 3, when viewed in the facing direction of the base portion 30 and the cover portion 60, the entire magnetic core 10 is accommodated inside an outline of the cover portion 60.

Note that the expression “the entire magnetic core 10 is accommodated inside an outline of the cover portion 60” as used herein means that the outline of the magnetic core 10 does not protrude outward from the outline of the cover portion 60 in plan view, and the outline of the magnetic core 10 may overlap the outline of the cover portion 60, for example.

With such a configuration, each of the plurality of divided cores 11, that is, the entire magnetic core 10 can be favorably supported by the base portion 30.

More specifically, in the case of the present embodiment, the longitudinal dimension of the entire cover portion 60 (the core arrangement portion 40 and the plate-shaped portion 35) is set to be substantially equal to the longitudinal dimension of the magnetic core 10 (an assembly of the first magnetic core 11a and the second magnetic core 11b). Similarly, the horizontal dimension of the entire cover portion 60 (same as above) is set substantially equal to the horizontal dimension of the magnetic core 10 (same as above).

As illustrated in FIG. 6, the outer surface of the base portion 12 of the first magnetic core 11a is disposed substantially flush with a left side end surface of the cover portion 60, and the outer surface of the base portion 12 of the second magnetic core 11b is disposed substantially flush with a right side end surface of the cover portion 60. As illustrated in FIG. 4, the respective outer surfaces of the outer leg 13 on the front side of the first magnetic core 11a and the outer leg 13 on the front side of the second magnetic core 11b are disposed substantially flush with a front end surface of the cover portion 60. Similarly, the respective outer surfaces of the outer leg 13 on the rear side of the first magnetic core 11a and the outer leg 13 on the rear side of the second magnetic core 11b are arranged substantially flush with a rear end surface of the cover portion 60.

Here, as illustrated in FIGS. 1, 5, and 6, the cover portion 60 further includes the positioning protruding portion 66 for positioning the magnetic core 10.

The positioning protruding portion 66 extends from the facing surface 61 of the cover portion 60 toward the magnetic core 10, and restricts the magnetic core 10 from approaching the cover portion 60 in the facing direction of the base portion 30 and the cover portion 60.

Thus, the height position of the magnetic core 10 with respect to the main body member 20 can be easily positioned in the vertical direction. Further, rattling of the magnetic core 10 in the vertical direction can be favorably suppressed.

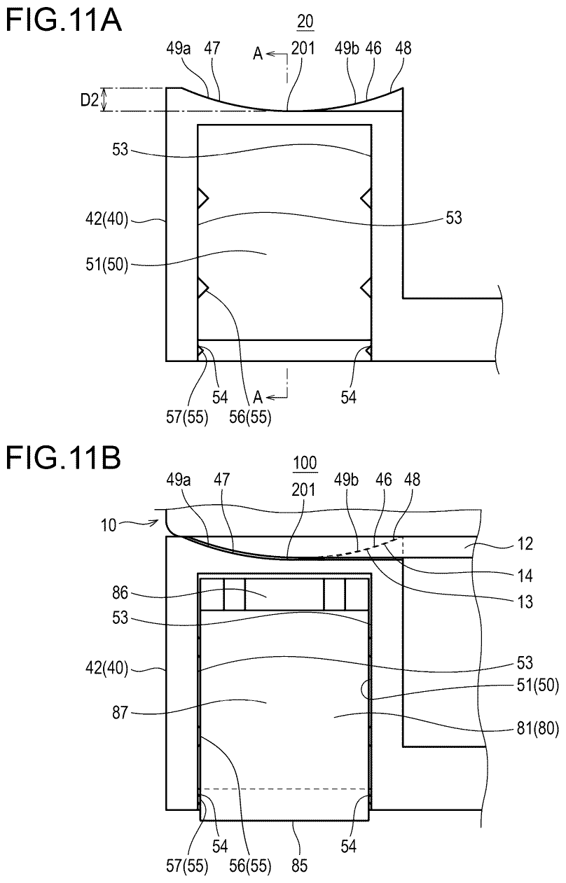

Further, in the case of the present embodiment, as illustrated in FIGS. 6 and 11B and the like, a concave portion 46 that is recessed toward a side opposite to the magnetic core 10 side is formed in a portion (in the case of the present embodiment, an upper surface of the core arrangement portion 40) of the facing surface 31 of the base portion 30, and the first convex curved surface 14 of the magnetic core 10 is disposed in the concave portion 46.

Thus, the magnetic core 10 can be favorably held by the base portion 30 while the magnetic core 10 has the first convex curved surface 14.

More specifically, at least a portion of the first convex curved surface 14 of the second portion (in the present embodiment, the pair of outer legs 13) of the magnetic core 10 is disposed in the concave portion 46.

Thus, it is possible to suppress the coil 90 from interfering with the base portion 30 while holding the magnetic core 10 well by the base portion 30.

Moreover, the concave portion 46 includes a concave curved surface 47 that is recessed toward the side opposite to the magnetic core 10 side, and the concave curved surface 47 is in surface contact with the first convex curved surface 14 of the magnetic core 10. That is, the first convex curved surface 14 is engaged with the concave curved surface 47.

Thus, the magnetic core 10 can be easily positioned with respect to the base portion 30. Furthermore, it is also possible to suppress relative displacement of the position of the magnetic core 10 with respect to the base portion 30.

Note that, in the present invention, it is sufficient if at least a portion of the first convex curved surface 14 is in surface contact with the concave curved surface 47. That is, it is sufficient if at least a portion of the first convex curved surface 14 is engaged with the concave curved surface 47.

As illustrated in FIGS. 1, 3, 5, 6, and the like, in the case of the present embodiment, the upper surface of the core arrangement portion 40 (the first core arrangement portion 42 and the second core arrangement portion 44) is the concave portion 46 and eventually the concave curved surface 47.

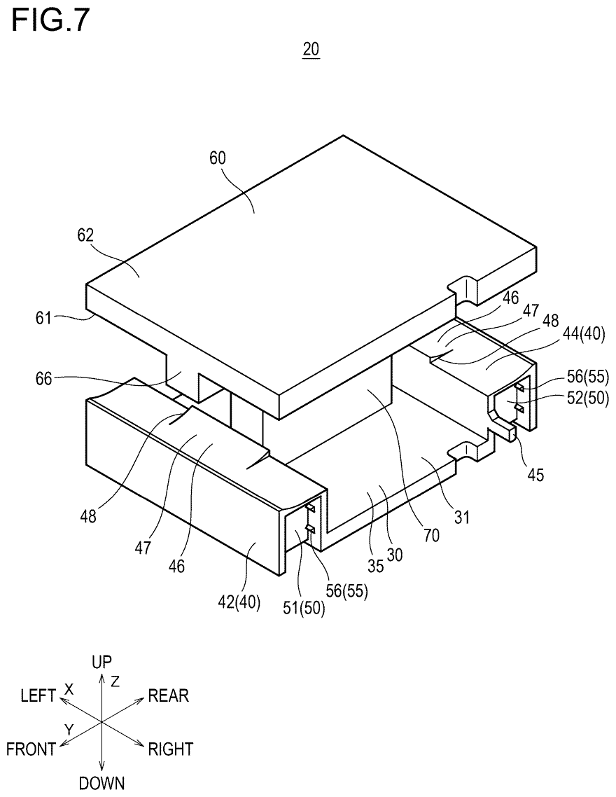

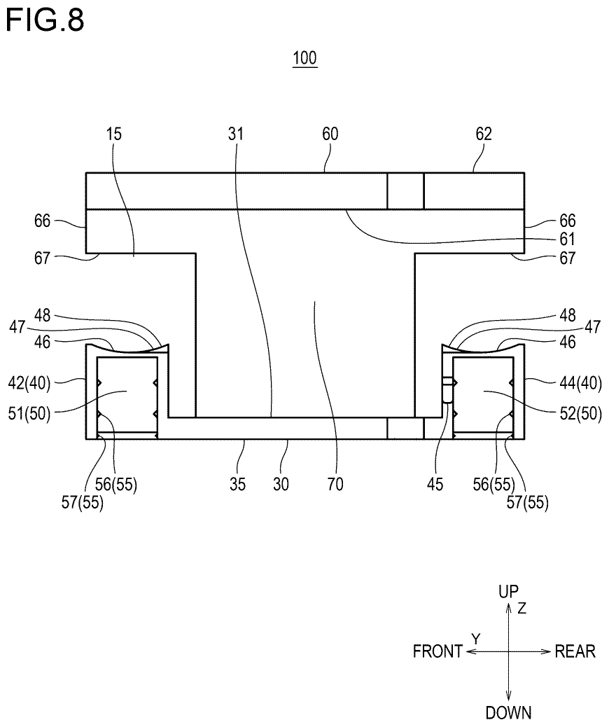

More specifically, as illustrated in FIGS. 7 and 8, in the core arrangement portion 40, each of upper surfaces of a left end portion and a right end portion is a concave curved surface corresponding to the first convex curved surface 14 of the base portion 12 of the magnetic core 10, and an upper surface of an intermediate portion (a portion between the left end portion and the right end portion) is a concave curved surface corresponding to the first convex curved surface 14 of the outer leg 13.

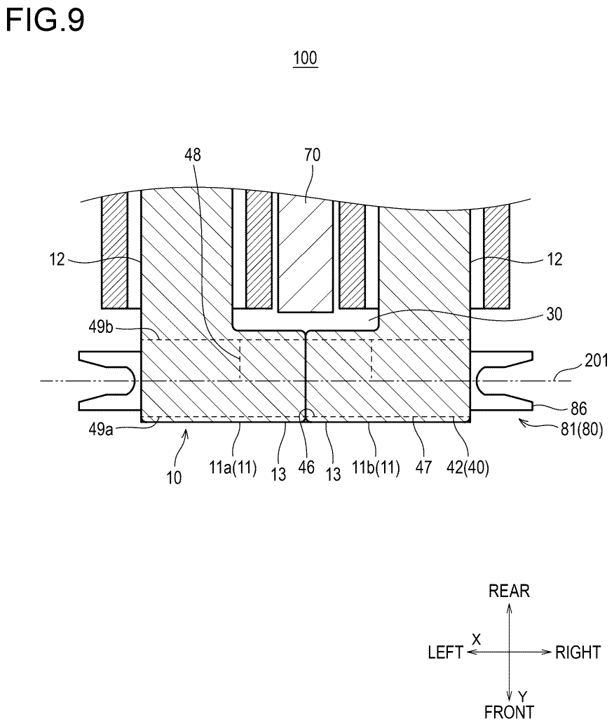

More specifically, with respect to a virtual line 201 illustrated in FIGS. 9 and 11B on the upper surface of each of the left end portion and the right end portion of the core arrangement portion 40 (the first core arrangement portion 42 and the second core arrangement portion 44), an outer portion 49a on the outside constitutes a portion of the concave curved surface 47. Note that the virtual line 201 here is a straight line that divides the core arrangement portion 40 into two equal parts in the extending direction (left-right direction) of the core arrangement portion 40 in plan view.

As illustrated in FIGS. 11A and 11B, when viewed in the extending direction (left-right direction) of the core arrangement portion 40, the outer portion 49a is a concave curved surface inclined downward from a position slightly offset inward from an outer side edge of the outer portion 49a toward an intermediate position (the position of the virtual line 201) of the upper surface of the core arrangement portion 40. Note that an outer side edge portion of the outer portion 49a is formed slightly flat.

On the other hand, on the upper surface of each of the left end portion and the right end portion of the core arrangement portion 40, an inner portion 49b with respect to the virtual line 201 is formed substantially flat and disposed horizontally.

In the case of the present embodiment, the front end portion of the first convex curved surface 14 of the base portion 12 of the first magnetic core 11a is in surface contact with and engaged with the upper surface of the left end portion of the first core arrangement portion 42, and the rear end portion of the first convex curved surface 14 is in surface contact with and engaged with the upper surface of the left end portion of the second core arrangement portion 44. Similarly, the front end portion of the first convex curved surface 14 of the base portion 12 of the second magnetic core 11b is in surface contact with and engaged with the upper surface of the right end portion of the first core arrangement portion 42, and the rear end portion of the first convex curved surface 14 is in surface contact with and engaged with the upper surface of the right end portion of the second core arrangement portion 44. Note that, as illustrated in FIG. 11B, the outer side edge portion of the outer portion 49a of the core arrangement portion 40 is formed slightly flat, and a flat side edge portion of the lower surface of the base portion 12 is in surface contact with this flat portion. Accordingly, the positional shift of the base portion 12 with respect to the concave portion 46 toward the outside is restricted.

On the other hand, substantially the entire upper surface of the intermediate portion of the core arrangement portion 40 (the first core arrangement portion 42 and the second core arrangement portion 44) constitutes a portion of the concave curved surface 47.

More specifically, on the upper surface of the intermediate portion of the core arrangement portion 40, both the outer portion 49a and the inner portion 49b with respect to the virtual line 201 are concave curved surfaces.

More specifically, in the intermediate portion of the core arrangement portion 40, an inner portion with respect to the virtual line 201 constitutes a raised portion 48 (see FIGS. 11A and 11B) gradually raised inward and upward. When viewed in the extending direction (left-right direction) of the core arrangement portion 40, the upper surface of the raised portion 48 is a concave curved surface inclined upward inward from an intermediate position (the position of the virtual line 201) of the upper surface of the core arrangement portion 40. Then, the upper surface (inner portion 49b) of the raised portion 48 and the outer portion 49a of the upper surface of the core arrangement portion 40 constitutes a concave curved surface 47 recessed downward.

In the case of the present embodiment, the first convex curved surface 14 of the outer leg 13 on the front side of each of the first magnetic core 11a and the second magnetic core 11b is in surface contact with the upper surface of the intermediate portion of the first core arrangement portion 42. Similarly, the first convex curved surface 14 of the outer leg 13 on the rear side of each of the first magnetic core 11a and the second magnetic core 11b is in surface contact with the upper surface of the intermediate portion of the second core arrangement portion 44.

With such a configuration, the magnetic core 10 can be arranged in the core arrangement portion 40 so that both the first convex curved surface 14 of the base portion 12, the outer leg 13, and the first convex curved surface 14 are brought into surface contact with the upper surface (concave curved surface 47) of the core arrangement portion 40.

In the case of the present embodiment, a maximum depth (D2 illustrated in FIG. 11A) of the concave portion 46 is, for example, preferably equal to or more than 1/20 and equal to or less than ⅕ of the maximum thickness dimension (T2 illustrated in FIG. 10B) of the magnetic core 10, and more preferably equal to or more than 1/15 and equal to or less than 1/10 of the maximum thickness dimension T2 of the magnetic core 10.

Further, as described above, the cover portion 60 further includes the positioning protruding portion 66 that positions the magnetic core 10. In the case of the present embodiment, as illustrated in FIGS. 5 and 8, the cover portion 60 has a pair of front and rear positioning protruding portions 66 as the positioning protruding portions 66.

For example, the pair of front and rear positioning protruding portions 66 are set to have the same shape and the same dimension, and are arranged to be longitudinally symmetrical to each other.

The positioning protruding portion 66 on the front side extends downward from a lower surface of a front end portion of the main body portion 62 of the cover portion 60, for example. Furthermore, the positioning protruding portion 66 on the front side is formed in a substantially rectangular parallelepiped shape elongated in the front-rear direction, and a rear end of the positioning protruding portion 66 is connected to a front end surface of the connecting portion 70. A front end surface of the positioning protruding portion 66 on the front side is disposed to be flush with a front end surface of the main body portion 62. The lower surface 67 of the positioning protruding portion 66 on the front side is formed flat and arranged horizontally. A left side surface of the positioning protruding portion 66 on the front side is disposed to be flush with a left side surface of the connecting portion 70, and a right side surface of the positioning protruding portion 66 is disposed to be flush with a right side surface of the connecting portion 70. Similarly, the positioning protruding portion 66 on the rear side extends downward from, for example, the lower surface of the rear end portion of the main body portion 62 of the cover portion 60. Furthermore, the positioning protruding portion 66 on the rear side is formed in a substantially rectangular parallelepiped shape elongated in the front-rear direction, and a front end of the positioning protruding portion 66 is connected to a rear end surface of the connecting portion 70. A rear end surface of the positioning protruding portion 66 on the rear side is disposed flush with a rear end surface of the main body portion 62. The lower surface 67 of the positioning protruding portion 66 on the rear side is formed flat and arranged horizontally. A left side surface of the positioning protruding portion 66 on the rear side is disposed to be flush with the left side surface of the connecting portion 70, and the right side surface of the positioning protruding portion 66 is disposed to be flush with the right side surface of the connecting portion 70.

As illustrated in FIG. 6, the positioning protruding portion 66 on the front side is disposed above a boundary portion between the outer leg 13 on the front side of the first magnetic core 11a and the outer leg 13 on the front side of the second magnetic core 11b. Then, a slight gap is formed between the lower surface 67 of the positioning protruding portion 66 on the front side and each of the upper surfaces of the outer leg 13 on the front side of the first magnetic core 11a and the outer leg 13 on the front side of the second magnetic core 11b.

Similarly, the positioning protruding portion 66 on the rear side is disposed above a boundary portion between the outer leg 13 on the rear side of the first magnetic core 11a and the outer leg 13 on the rear side of the second magnetic core 11b. Then, a slight gap is formed between the lower surface 67 of the positioning protruding portion 66 on the rear side and each upper surface of the outer leg 13 on the rear side of the first magnetic core 11a and the outer leg 13 on the rear side of the second magnetic core 11b.

With such a configuration, the first magnetic core 11a and the second magnetic core 11b can be easily positioned with respect to the main body member 20 in the vertical direction. Further, rattling of both the first magnetic core 11a and the second magnetic core 11b in the vertical direction can be suppressed.

In the case of the present embodiment, a shortest distance (D1 illustrated in FIG. 5) between the lower surface 67 of the positioning protruding portion 66 and the second convex curved surface 15 in the vertical direction is smaller than a separation distance (D3 illustrated in FIG. 6) between an upper end of the winding portion 94 and the lower surface of the main body portion 62.

With such a configuration, the first magnetic core 11a and the second magnetic core 11b can be positioned with high accuracy with respect to the main body member 20 in the vertical direction. Further, rattling of both the first magnetic core 11a and the second magnetic core 11b in the vertical direction can be suppressed more reliably. Furthermore, even if the magnetic core 10 attempts to rise up from the core arrangement portion 40, the second convex curved surface 15 can abut on the lower surface 67 of the positioning protruding portion 66 first, and thus, it is possible to suppress wear of the insulating coating of the winding 93 due to interference of the winding 93 with the lower surface of the main body portion 62.

As described above, the coil component 100 includes the plurality of (for example, four) terminal members 80 electrically connected to the coil 90.

In the case of the present embodiment, each of the plurality of terminal members 80 is formed in the same shape and the same dimension.

Here, as illustrated in FIGS. 8 to 12B, for example, a fitting recess 50 is formed in the base portion 30, and the terminal member 80 is fitted into the fitting recess 50 by a fitting structure (in the case of the present embodiment, a plurality of protrusions 55 to be described later).

With such a configuration, the terminal member 80 can be easily fixed to the core arrangement portion 40 without using an adhesive or the like.

More specifically, in the case of the present embodiment, as illustrated in FIG. 8, the base portion 30 includes, as the fitting recesses 50, a pair of left and right first fitting recesses 51 formed in the first core arrangement portion 42 and a pair of left and right second fitting recesses 52 formed in the second core arrangement portion 44.

Then, among the four terminal members 80, two terminal members 80 (hereinafter, the first terminal member 81) are fitted into the first fitting recess 51, and the remaining two terminal members 80 (hereinafter, the second terminal member 82) are fitted into the second fitting recess 52.

The first terminal members 81 are arranged symmetrically to each other in the first core arrangement portion 42. Similarly, the second terminal members 82 are arranged symmetrically to each other in the second core arrangement portion 44.

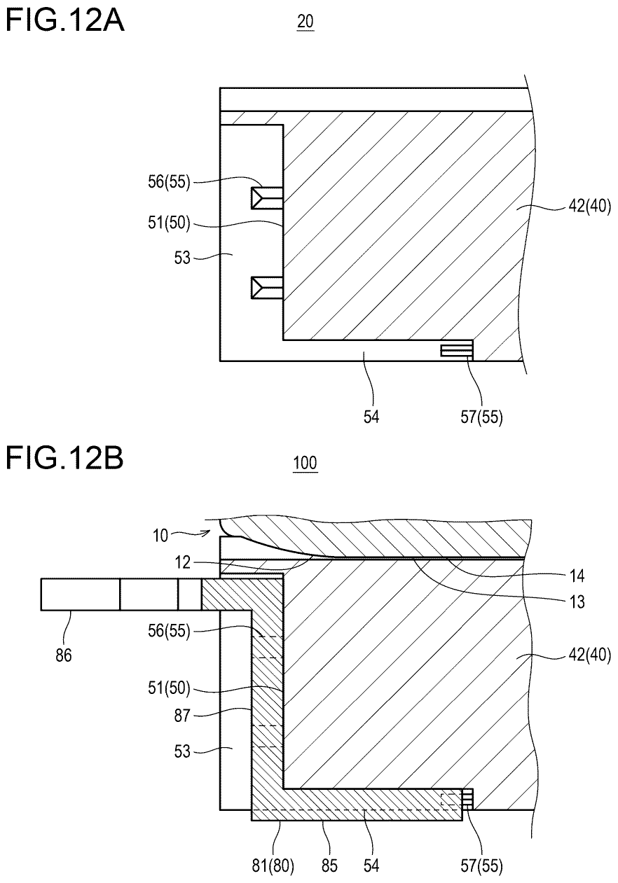

Each terminal member 80 is formed by, for example, bending a long plate-shaped metal member into a substantially Z shape (see FIGS. 6 and 12B).

More specifically, the terminal member 80 is bent in two stages in a longitudinal direction thereof, and one end portion and the other end portion of the terminal member 80 face each other in the vertical direction and are arranged horizontally, while an intermediate portion (hereinafter, vertical portion 87) (intermediate portion in the longitudinal direction) between the one end portion and the other end portion is disposed vertically. Further, in the terminal member 80, one end portion protrudes inward and is disposed on the lower side with respect to the vertical portion 87, and the other end portion protrudes outward and is disposed on the upper side. Then, in the terminal member 80, of the one end portion and the other end portion, one end portion is an external terminal 85 that is externally connected when the coil component 100 is mounted, and the other end portion is an internal terminal 86 that is connected to the winding 93 of the coil 90.

As illustrated in FIG. 4, the external terminal 85 is formed in a substantially rectangular shape elongated in the left-right direction in plan view. Similarly, as illustrated in FIG. 11B, the shape of the vertical portion 87 viewed in the left-right direction is formed in a substantially rectangular shape elongated in the vertical direction.

On the other hand, the internal terminal 86 is formed in a bifurcated shape opened toward the distal end side (outward). As an example, an end portion of the lead wire 95 (the winding wire 93 of the coil 90) drawn out from the winding portion 94 of the coil 90 is fixed to the internal terminal 86 by resistance welding in a state of being pinched by the bifurcated portion of the internal terminal 86. However, in the present invention, the method of fixing the winding 93 to the internal terminal 86 is not limited to this example, and the winding may be fixed by binding or soldering, for example.

In the case of the present embodiment, the pair of left and right first fitting recesses 51 is formed to have the same shape and the same dimension, and is disposed symmetrically. Similarly, the pair of left and right second fitting recesses 52 is formed to have the same shape and the same size, and is arranged symmetrically. Further, the first fitting recesses 51 and the second fitting recesses 52 are formed to have the same shape and the same dimension.

More specifically, in the case of the present embodiment, the fitting structure in which the terminal member 80 is fitted into the fitting recess 50 is one or a plurality of protrusions 55 (in the case of the present embodiment, six protrusions 55).

When the terminal member 80 is fitted into the fitting recess 50, the terminal member 80 is press-fitted into the fitting recess 50 while crushing the plurality of protrusions 55.

With such a configuration, the terminal member 80 can be easily fixed favorably to the core arrangement portion 40 without using an adhesive or the like. Further, for example, even if there is a variation in the size of the terminal member 80 with respect to the fitting recess 50, the protrusion 55 can absorb this variation in the size.

However, in the present invention, the method of fixing the terminal member 80 to the core arrangement portion 40 (base portion 30) is not limited to the fitting structure, and for example, the terminal member 80 may be fixed to the base portion 30 by a method such as insert molding, crimping, or adhesion.

More specifically, as illustrated in FIGS. 11A and 12A, the fitting recess 50 (each first fitting recess 51 and each second fitting recess 52) includes a pair of first side surface portions 53 facing each other and a pair of second side surface portions 54 facing each other. Note that FIGS. 7, 8, 11A, and 12A illustrate the main body member 20 in a state before the terminal member 80 is press-fitted into the fitting recess 50.

As illustrated in FIGS. 11B and 12B, the vertical portion 87 of the terminal member 80 is disposed between the pair of first side surface portions 53, and the internal terminal 86 of the terminal member 80 is disposed between the pair of second side surface portions 54.

The protrusion 55 includes a plurality of (for example, four) first protrusions 56 formed on the pair of first side surface portions 53 and a plurality of (for example, two) second protrusions 57 formed on the pair of second side surface portions 54.

In the case of the present embodiment, two first protrusions 56 are formed on each of the pair of first side surface portions 53. Then, as illustrated in FIG. 11B, the first protrusions 56 formed on the one first side surface portion 53 protrude toward the vertical portion 87 of the terminal member 80, and are crushed between the vertical portion 87 and the one first side surface portion 53. Similarly, the first protrusions 56 formed on the other first side surface portion 53 protrudes toward the vertical portion 87 of the terminal member 80, and is crushed between the vertical portion 87 and the other first side surface portion 53. Then, the vertical portion 87 is fitted to the fitting recess 50 in a state of being pressed toward the other first side surface portion 53 side by the first protrusions 56 formed on the one first side surface portion 53 and pressed toward the one first side surface portion 53 side by the first protrusions 56 formed on the other first side surface portion 53.

Further, two second protrusions 57 are formed on each of the pair of second side surface portions 54. Then, the second protrusions 57 formed on the pair of second side surface portions 54 protrudes toward the external terminal 85 of the terminal member 80, and is crushed between the external terminal 85 and the second side surface portion 54. Then, the second protrusions 57 formed on the other second side surface portion 54 protrudes toward the external terminal 85 of the terminal member 80, and is crushed between the external terminal 85 and the second side surface portion 54. Then, the external terminal 85 is fitted to the fitting recess 50 in a state of being pressed toward the other second side surface portion 54 side by the second protrusions 57 formed on the one second side surface portion 54 and pressed toward the one second side surface portion 54 side by the second protrusions 57 formed on the other second side surface portion 54.

As illustrated in FIGS. 3 and 4, each of the external terminal 85 and the vertical portion 87 of each terminal member 80 is accommodated inside the fitting recess 50 and the outline of the base portion 30 in plan view. On the other hand, the internal terminal 86 of each terminal member 80 protrudes outward from the fitting recess 50 and the outline of the base portion 30 in plan view.

In the case of the present embodiment, in this manner, each terminal member 80 is fitted into the corresponding fitting recess 50.

The coil component 100 according to the present embodiment is configured as described above. As an example, the coil component 100 can be used as a common mode choke coil. However, the application of the coil component 100 is not limited to this example.

Assembly of the coil component 100 can be performed, for example, as follows.

First, each winding 93 of the coil 90 (first coil 91 and second coil 92) is wound around the base portion 12 of each of the first magnetic core 11a and the second magnetic core 11b.

Next, each of the first magnetic core 11a and the second magnetic core 11b is disposed on the core arrangement portion 40. More specifically, the outer leg 13 on the front side of the first magnetic core 11a is inserted from the left side onto the upper surface of the left end portion of the first core arrangement portion 42, and the outer leg 13 on the rear side of the first magnetic core 11a is inserted from the left side onto the upper surface of the left end portion of the second core arrangement portion 44. Similarly, the outer leg 13 on the front side of the second magnetic core 11b is inserted from the right side onto the upper surface of the right end portion of the first core arrangement portion 42, and the outer leg 13 on the rear side of the second magnetic core 11b is inserted from the right side onto the upper surface of the right end portion of the second core arrangement portion 44. In this manner, the magnetic core 10 is disposed between the facing surface 61 of the cover portion 60 and the facing surface 31 of the base portion 30. Furthermore, the first convex curved surface 14 of the magnetic core 10 is engaged with the concave portion 46 (concave curved surface 47) of the core arrangement portion 40.

Next, the first magnetic core 11a and the second magnetic core 11b are fixed to each other by an adhesive (not shown in the drawings). Thus, the magnetic core 10 having an annular shape in plan view is configured.

Here, as described above, the cover portion 60 has the positioning protruding portion 66 that restricts the magnetic core 10 from approaching the cover portion 60. Therefore, for example, the positional relationship between the first magnetic core 11a and the second magnetic core 11b and the desired positional relationship between the magnetic core 10 and the main body member 20 in the vertical direction can be easily implemented without using a dedicated jig. Therefore, ease of manufacturing the coil component 100 can be improved.

Next, the end portion of each winding 93 of the coil 90 is fixed to the internal terminal 86 of the corresponding terminal member 80. In the present embodiment, as an example, the end portion of the winding 93 is fixed to the internal terminal 86 by resistance welding.

In this manner, the coil component 100 is obtained.

Although the embodiment has been described above with reference to the drawings, these are examples of the present invention, and various configurations other than the above can be adopted.

For example, in the above description, an example has been described in which the magnetic core 10 includes two U cores as the divided core 11, but the present invention is not limited to this example, and the magnetic core 10 may include a U core and an I core, may include an E core and an I core, or may include two E cores as the divided core 11.

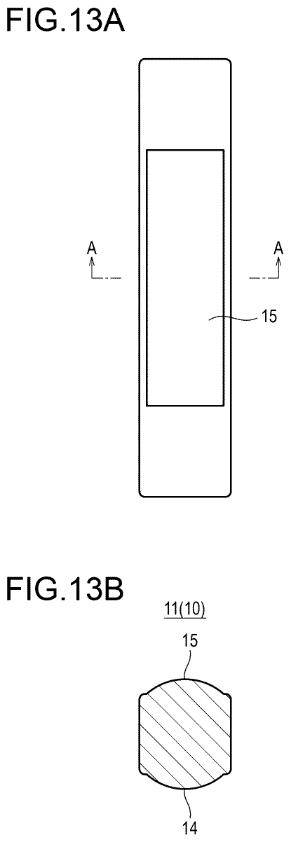

Note that, in a case where the magnetic core 10 includes an I core as the divided core 11, as illustrated in FIGS. 13A and 13B, it is preferable that, also in the I core, a surface on the base portion 30 side is a first convex curved surface 14 convex toward the base portion 30, and a surface on the cover portion 60 side is a second convex curved surface 15 convex toward the cover portion 60. In this case, in the I core, at least a portion of the surface on the cover portion 60 side may be the second convex curved surface 15 as illustrated in FIG. 13A, or the entire surface on the cover portion 60 side may be the second convex curved surface 15. Similarly, at least a portion of the surface of the I core on the base portion 30 side may be the first convex curved surface 14, or the entire surface on the base portion 30 side may be the first convex curved surface 14.

Similarly, when the magnetic core 10 includes an E core as the divided core 11, the surface of the E core on the base portion 30 side is preferably the first convex curved surface 14 convex toward the base portion 30, and the surface on the cover portion 60 side is preferably the second convex curved surface 15 convex toward the cover portion 60. In this case, in the E core, at least a portion of the surface on the cover portion 60 side may be the second convex curved surface 15, or the entire surface on the cover portion 60 side may be the second convex curved surface 15. Similarly, at least a portion of the surface of the E core on the base portion 30 side may be the first convex curved surface 14, or the entire surface on the base portion 30 side may be the first convex curved surface 14.

Furthermore, in the above description, an example in which the magnetic core 10 is divided into two divided cores 11 has been described, but the magnetic core 10 may be divided into, for example, three or more divided cores 11.

Although the example in which the coil 90 is directly wound around the magnetic core 10 has been described above, the present invention is not limited to this example, and for example, the coil 90 may be indirectly wound around the magnetic core 10 via a bobbin portion (not shown in the drawings). In this case, the bobbin portion is preferably configured by a portion of the main body member 20.

The present embodiment includes the following technical ideas.
(1) a coil component including:
a magnetic core formed in an annular shape and having a structure divided into a plurality of divided cores in a circumferential direction;
a coil wound around the magnetic core;
a main body member holding the magnetic core; and
a plurality of terminal members made of metal and each electrically connected to the coil, in which
the main body member integrally includes a base portion provided with the plurality of terminal members and in which the magnetic core is disposed, a cover portion covering the magnetic core, and a connecting portion connecting the base portion and the cover portion to each other.
(2) The coil component according to (1), in which
the base portion and the cover portion have respective facing surfaces facing each other,
the connecting portion is interposed between the facing surfaces of the base portion and the cover portion, and connects the facing surfaces to each other, and
the plurality of divided cores is disposed on the facing surface of the base portion.
(3) The coil component according to (2), in which the connecting portion connects a central portion of the base portion and a central portion of the cover portion to each other, and
the plurality of divided cores surrounds a periphery of the connecting portion.
(4) The coil component according to (2) or (3), in which the entire magnetic core is accommodated inside an outline of the base portion when viewed in a facing direction of the base portion and the cover portion.
(5) The coil component according to any one of (2) to (4), in which the entire magnetic core is accommodated inside an outline of the cover portion when viewed in a facing direction of the base portion and the cover portion.
(6) The coil component according to any one of (2) to (5), in which
the cover portion includes a positioning protruding portion that positions the magnetic core, and
the positioning protruding portion extends from the facing surface of the cover portion toward the magnetic core, and
restricts the magnetic core from approaching the cover portion in a facing direction of the base portion and the cover portion.
(7) The coil component according to any one of (2) to (6), in which in the magnetic core, an entire surface on the base portion side is a first convex curved surface that is convex toward the base portion, and an entire surface on the cover portion side is a second convex curved surface that is convex toward the cover portion.
(8) The coil component according to (7), in which a concave portion that is recessed toward a side opposite to a side of the magnetic core is formed in a portion of the facing surface of the base portion, and
the first convex curved surface of the magnetic core is disposed in the concave portion.
(9) The coil component according to (8), in which the magnetic core includes a first portion around which the coil is wound and a second portion around which the coil is not wound, and
at least a portion of the first convex curved surface of the second portion is disposed in the concave portion.
(10) The coil component according to (8) or (9), in which the concave portion includes a concave curved surface that is recessed toward the side opposite to the side of the magnetic core, and
the concave curved surface is in surface contact with the first convex curved surface of the magnetic core.
(11) The coil component according to any one of (1) to (10), in which
a fitting recess is formed in the base portion, and
the terminal member is fitted in the fitting recess by a fitting structure.

1. A coil component comprising:
a magnetic core formed in an annular shape and having a structure divided into a plurality of divided cores in a circumferential direction;
a coil wound around the magnetic core;
a main body member holding the magnetic core; and
a plurality of terminal members made of metal and each electrically connected to the coil, wherein
the main body member integrally includes a base portion provided with the plurality of terminal members and in which the magnetic core is disposed, a cover portion covering the magnetic core, and a connecting portion connecting the base portion and the cover portion to each other.

2. The coil component according to claim 1, wherein
the base portion and the cover portion have respective facing surfaces facing each other,
the connecting portion is interposed between the facing surfaces of the base portion and the cover portion, and connects the facing surfaces to each other, and the plurality of divided cores is disposed on the facing surface of the base portion.

3. The coil component according to claim 2, wherein
the connecting portion connects a central portion of the base portion and a central portion of the cover portion to each other, and
the plurality of divided cores surrounds a periphery of the connecting portion.

4. The coil component according to claim 2,
wherein the entire magnetic core is accommodated inside an outline of the base portion when viewed in a facing direction of the base portion and the cover portion.

5. The coil component according to claim 2, wherein the entire magnetic core is accommodated inside an outline of the cover portion when viewed in a facing direction of the base portion and the cover portion.

6. The coil component according to claim 2, wherein
the cover portion includes a positioning protruding portion that positions the magnetic core,
and the positioning protruding portion extends from the facing surface of the cover portion toward the magnetic core, and restricts the magnetic core from approaching the cover portion in a facing direction of the base portion and the cover portion.

7. The coil component according to claim 2, wherein in the magnetic core, an entire surface on the base portion side is a first convex curved surface that is convex toward the base portion, and an entire surface on the cover portion side is a second convex curved surface that is convex toward the cover portion.

8. The coil component according to claim 7, wherein
a concave portion that is recessed toward a side opposite to a side of the magnetic core is formed in a portion of the facing surface of the base portion, and
the first convex curved surface of the magnetic core is disposed in the concave portion.

9. The coil component according to claim 8, wherein
the magnetic core includes a first portion around which the coil is wound and a second portion around which the coil is not wound, and
at least a portion of the first convex curved surface of the second portion is disposed in the concave portion.

10. The coil component according to claim 8, wherein
the concave portion includes a concave curved surface that is recessed toward the side opposite to the side of the magnetic core, and
the concave curved surface is in surface contact with the first convex curved surface of the magnetic core.

11. The coil component according to claim 1, wherein
a fitting recess is formed in the base portion, and
the terminal member is fitted in the fitting recess by a fitting structure.
